(19) United States
(12) Patent Application Publication
(10) Pub. No.: US 2009/0288479 A1
(43) Pub. Date: Nov. 26, 2009

(54) STANDING WAVE FLUIDIC AND BIOLOGICAL TOOLS

(76) Inventors: SHANE C. WOODY, Charlotte, NC (US); Bethany A. Woody, Charlotte, NC (US); Marcin B. Bauza, Charlotte, NC (US); Stuart T. Smith, Charlotte, NC (US); Nilay Chakraborty, Boston, MA (US)

Correspondence Address: Clements Bernard PLLC, 1901 Roxborough Road, Suite 250, Charlotte, NC, 28211, US

(21) Appl. No.: 12/395,213

(22) Filed: Feb. 27, 2009

Related U.S. Application Data
(63) Continuation-in-part of application No. 11/956,915, filed on Dec. 14, 2007.
Application No. 11/956,915 is a continuation-in-part of application No. 11/818,669, filed on Jun. 15, 2007.
Application No. 11/818,669 is a continuation-in-part of application No. 10/989,744, filed on Nov. 16, 2004, now Pat. No. 7,278,297.
(60) Provisional application No. 61/031,901, filed on Feb. 27, 2008.
(60) Provisional application No. 61/054,660, filed on May 20, 2008.
(60) Provisional application No. 61/122,535, filed on Dec. 15, 2008.
(60) Provisional application No. 61/122,518, filed on Dec. 15, 2008.
(60) Provisional application No. 60/874,772, filed on Dec. 14, 2006.
(60) Provisional application No. 60/931,724, filed on May 25, 2007.
(60) Provisional application No. 60/813,962, filed on Jun. 15, 2006.
(60) Provisional application No. 60/931,724, filed on May 25, 2007.
(60) Provisional application No. 60/520,500, filed on Nov. 17, 2003.

(51) Int. Cl. G01B 5/28

(52) U.S. Cl. 73/105

(57) ABSTRACT

The present invention provides standing wave fluidic and biological tools, including: at least one elongated fiber that has mesoscale (i.e. milliscale), microscale, nanoscale, or picoscale dimensions, the at least one elongated fiber having a first end and a second end; and an actuator coupled to the first end of the at least one elongated fiber, wherein the actuator is operable for applying oscillation cycles to the at least one elongated fiber in one or more directions, and wherein the actuator is operable for generating a standing wave in the at least one elongated fiber. These standing wave fluidic and biological tools are selectively disposed in a fluid to provide a function such as mixing the fluid, measuring the viscosity of the fluid, attracting particles in the fluid, shepherding particles in the fluid, providing propulsive force in the fluid, pumping the fluid, dispensing the fluid, sensing particles in the fluid, and detecting particles in the fluid, among others.

### CROSS-REFERENCE TO RELATED APPLICATION(S)

The present non-provisional patent application claims the benefit of priority of U.S. Provisional Patent Application No. 61/031,901, filed on Feb. 27, 2008, and entitled “STANDING WAVE FLUIDIC AND BIOLOGICAL TOOLS;” U.S. Provisional Patent Application No. 61/054,660, filed on May 20, 2008, and entitled “STANDING WAVE FLUIDIC AND BIOLOGICAL TOOLS;” U.S. Provisional Patent Application No. 61/122,535, filed on Dec. 15, 2008, and entitled “MICROSCALE LIQUID HANDLING AND MICROMIXING DEVICE FOR ALL HIGH THROUGHPUT DRUG DISCOVERY PROCESSES;” and U.S. Provisional Patent Application No. 61/122,518, also filed on Dec. 15, 2008, and entitled “STANDING WAVE SENSOR FOR VISCOMETRY AND RHEOLOGY OF MICROSAMPLES;” the contents of all of which are incorporated in full by reference herein. The present non-provisional patent application is a continuation-in-part of co-pending U.S. patent application Ser. No. 11/956,915, filed on Dec. 14, 2007, and entitled “MULTI-DIMENSIONAL STANDING WAVE PROBE FOR MICROSCALE AND NANOSCALE MEASUREMENT, MANIPULATION, AND SURFACE MODIFICATION,” the contents of which are also incorporated in full by reference herein. U.S. patent application Ser. No. 11/956,915 claims the benefit of priority of U.S. Provisional Patent Application Nos. 60/874,772, filed on Dec. 14, 2006, and entitled “MULTI-DIMENSIONAL STANDING WAVE SENSOR WITH AN APPLICATION TO DIESEL MANUFACTURING” and 60/931,724, filed on May 25, 2007, and entitled “STANDING WAVE PROBES FOR MEASUREMENT, MANIPULATION, AND MODIFICATION ACROSS DIMENSIONAL SCALES,” the contents of both of which are further incorporated in full by reference herein. U.S. patent application Ser. No. 11/956,915 is a continuation in part of co-pending U.S. patent application Ser. No. 11/818,669, filed on Jun. 15, 2007, and entitled “SELF-SENSING TWEEZER DEVICES AND ASSOCIATED METHODS FOR MICRO AND NANOSCALE MANIPULATION AND ASSEMBLY,” which claims the benefit of priority of U.S. Provisional Patent Application Nos. 60/813,962, filed on Jun. 15, 2006, and entitled “SELF-SENSING TWEEZERS FOR MICRO-ASSEMBLY AND MANIPULATION” and 60/931,724, filed on May 25, 2007, and entitled “STANDING WAVE PROBES FOR MEASUREMENT, MANIPULATION, AND MODIFICATION ACROSS DIMENSIONAL SCALES,” the contents of all of which are still further incorporated in full by reference herein. U.S. patent application Ser. No. 11/818,669 is a continuation-in-part of previously co-pending U.S. patent application Ser. No. 10/989,744 (now U.S. Pat. No. 7,278,297), filed on Nov. 16, 2004, and entitled “AN OSCILLATING PROBE WITH A VIRTUAL PROBE TIP,” which claims the benefit of priority of U.S. Provisional Patent Application No. 60/520,500, filed on Nov. 17, 2003, and entitled “AN OSCILLATING PROBE WITH A VIRTUAL PROBE TIP,” the contents of both of which are still further incorporated in full by reference herein.

### FIELD OF THE INVENTION

The present invention relates generally to the mesoscale (i.e. milliscale), microscale, nanoscale, and picoscale technology fields. More specifically, the present invention relates to standing wave fluidic and biological tools that may be used in liquid, gas, solid state, multi-phase, and viscoelastic environments and combinations thereof These standing wave fluidic and biological tools have a wide range of novel applications of great importance to a variety of industries.

### BACKGROUND OF THE INVENTION

Commonly assigned U.S. Pat. No. 7,278,297 (Bauza et al.) provides an oscillating probe including an elongated rod having a first free end and a second end that is attached to an actuator that applies oscillation cycles to the elongated rod. The oscillation of the elongated rod during at least one complete oscillation cycle of the actuator causes the free end to move in at least a one-dimensional envelope, producing a defined virtual probe tip at the free end. The shape of this virtual probe tip is defined by both the characteristic shape of the oscillation of the free end and the geometry of the elongated rod. This oscillating probe may be used in microscale and nanoscale measurement, manipulation, and/or surface modification applications, for example.

Similarly, commonly assigned U.S. patent application Ser. No. 11/956,915 (Woody et al.) provides a multi-dimensional standing wave probe for microscale and nanoscale measurement, manipulation, and/or surface modification applications including a filament having a first free end and a second end that is attached to an actuator that applies oscillation cycles to the filament. The oscillation of the filament during at least one complete oscillation cycle of the actuator causes the free end to move in a multi-dimensional envelope, producing a defined virtual probe tip at the free end. The shape of this virtual probe tip is defined by both the characteristic shape of the oscillation of the free end and the geometry of the filament.

The principles of operation of this oscillating probe and multi-dimensional standing wave probe—namely the generation of a standing wave in a mesoscale (i.e. milliscale), microscale, nanoscale, or picoscale fiber and, optionally, the formation of a virtual probe tip—may be utilized in a wide range of novel applications of great importance to a variety of industries. The most promising of these novel applications include fluidic and biological applications that involve liquid, gas, solid state, multi-phase, and viscoelastic environments and combinations thereof, as described in greater detail herein.

### BRIEF SUMMARY OF THE INVENTION

In various exemplary embodiments, the present invention provides novel uses for the standing wave probes of U.S. Pat. No. 7,279,297 (Bauza et al.) and U.S. patent application Ser. No. 11/956,915 (Woody et al.), especially in fluidic and biological applications that involve liquid, gas, solid state, multi-phase, and viscoelastic environments and combinations thereof. As described in greater detail herein, these standing wave probes typically include a high-aspect ratio mesoscale (i.e. milliscale), microscale, nanoscale, or picoscale fiber that is directly or indirectly coupled to at least one actuator that applies oscillation cycles to the fiber, generating a standing wave in the fiber. The fiber may be constrained at one end, causing a virtual probe tip to be formed at the free end, or it may be constrained at both ends. In the later case, an actuator may be coupled to one or both ends of the fiber. Intervening constraints along the length of the fiber are also contemplated herein. In any case, the standing wave generated in the fiber is defined by both the characteristic shape of the oscillation cycles applied by the actuator(s) and the geometry of the fiber. The standing wave generated in the fiber may be along the longitudinal, lateral, or torsional direction of the fiber, or may produce a semicircular motion around the axis of rotation of the fiber, for example, resulting in spiral like movements that are a combination of lateral and torsional motions. Higher harmonic modes generated in the fiber produce higher potential and kinetic energy. Multiple standing wave probes, individually or collectively utilizing multiple fibers, may also be utilized in concert, as the configurations and methodologies of the present invention are very robust.

In one exemplary embodiment, the present invention provides a standing wave tool, including: at least one elongated fiber that has mesoscale dimensions or smaller, the at least one elongated fiber including at least a first end and a second end; and an actuator directly or indirectly coupled to the first end of the at least one elongated fiber, wherein the actuator is operable for applying oscillation cycles to the at least one elongated fiber in one or more directions, and wherein the actuator is operable for generating a standing wave in the at least one elongated fiber. Optionally, the second end of the at least one elongated fiber is unconstrained. Optionally, the second end of the at least one elongated fiber is constrained. Optionally, the at least one elongated fiber is constrained between the first end and the second end. Optionally, the standing wave tool also includes: an actuator directly or indirectly coupled to the second end of the at least one elongated fiber, wherein the actuator is operable for applying oscillation cycles to the at least one elongated fiber in one or more directions, and wherein the actuator is operable for generating a standing wave in the at least one elongated fiber. Preferably, the at least one elongated fiber is one of a substantially rod-like structure, a substantially beam-like structure, a substantially tube-like structure, a substantially planar structure, a structure of varying cross-section, a biological structure, and a combination thereof. Optionally, the at least one elongated fiber is a composite structure comprising a plurality of materials, such as a base material and a deposited or bonded material, or one material comprising a plurality of properties.

In another exemplary embodiment, the present invention provides a method for utilizing a standing wave tool in a fluidic and/or biological environment, including: providing at least one elongated fiber that has mesoscale dimensions or smaller, the at least one elongated fiber including at least a first end and a second end; providing an actuator directly or indirectly coupled to the first end of the at least one elongated fiber, wherein the actuator is operable for applying oscillation cycles to the at least one elongated fiber in one or more directions, and wherein the actuator is operable for generating a standing wave in the at least one elongated fiber; and disposing at least a portion of the at least one elongated fiber in a fluid. Optionally, the second end of the at least one elongated fiber is unconstrained. Optionally, the second end of the at least one elongated fiber is constrained. Optionally, the at least one elongated fiber is constrained between the first end and the second end. Optionally, the method for utilizing the standing wave tool also includes: providing an actuator directly or indirectly coupled to the second end of the at least one elongated fiber, wherein the actuator is operable for applying oscillation cycles to the at least one elongated fiber in one or more directions, and wherein the actuator is operable for generating a standing wave in the at least one elongated fiber. Preferably, the at least one elongated fiber is one of a substantially rod-like structure, a substantially beam-like structure, a substantially tube-like structure, a substantially planar structure, a structure of varying cross-section, a biological structure, and a combination thereof. Optionally, the at least one elongated fiber is a composite structure comprising a plurality of materials, such as a base material and a deposited or bonded material, or one material comprising a plurality of properties. Optionally, the method for utilizing the standing wave tool further includes quantifying a change in a frequency response function of the at least one elongated fiber. As contemplated herein, the at least one elongated fiber provides a function selected from the group consisting of mixing the fluid, measuring the viscosity of the fluid, attracting particles in the fluid, shepherding particles in the fluid, providing propulsive force in the fluid, pumping the fluid, dispensing the fluid, sensing particles in the fluid, detecting particles in the fluid, measuring a mechanical stiffness of particles in the fluid, wicking the fluid, and wicking particles in the fluid. Optionally, the method for utilizing the standing wave tool still further includes disposing at least a portion of the at least one elongated fiber concentrically within a channel structure. Optionally, the method for utilizing the standing wave tool still further includes removing at least a portion of the at least one elongated fiber from the fluid.

In a further exemplary embodiment, the present invention provides a standing wave tool, including: at least one elongated fiber that has mesoscale dimensions or smaller, the at least one elongated fiber including a first end and a second end; an actuator directly or indirectly coupled to the first end of the at least one elongated fiber, wherein the actuator is operable for applying oscillation cycles to the at least one elongated fiber in one or more directions, and wherein the actuator is operable for generating a standing wave in the at least one elongated fiber; and a receptor material disposed on a surface of the at least one elongated fiber, wherein the receptor material is operable for reacting with a target material disposed in a fluid, and wherein a frequency response function of the at least one elongated fiber changes when the receptor material reacts with the target material, thereby detecting/sensing the target material. Optionally, the receptor material is a biomolecule, such as an antibody, and the target material is a biomolecule, such as an antigen. In this exemplary embodiment, it should be noted that the target material may be attracted to the receptor material via surface tension and then wicked along the elongated fiber(s), for example. As an alternative, the target material may simply be attracted to and held by the elongated fiber(s), and then be detected by another external methodology, such as fluorescing, etc.

In a still further exemplary embodiment, the present invention provides a method for utilizing a standing wave tool in a fluidic and/or biological environment, including: providing at least one elongated fiber that has mesoscale dimensions or smaller, the at least one elongated fiber including a first end and a second end; providing an actuator coupled to the first end of the at least one elongated fiber, wherein the actuator is operable for applying oscillation cycles to the at least one elongated fiber in one or more directions, and wherein the actuator is operable for generating a standing wave in the at least one elongated fiber; providing a receptor material disposed on a surface of the at least one elongated fiber, wherein the receptor material is operable for reacting with a target material disposed in a fluid; and measuring a frequency response function of the at least one elongated fiber before and after the receptor material reacts with the target material, thereby detecting/sensing the target material. Optionally, the receptor material is a biomolecule, such as an antibody, and the target material is a biomolecule, such as an antigen.

### BRIEF DESCRIPTION OF THE DRAWINGS

The present invention is illustrated and described herein with reference to the various drawings, in which like reference numbers are used to denote like device components/method steps, as appropriate, and in which:

FIG. 1 is a schematic diagram illustrating one exemplary embodiment of the standing wave sensor of the present invention, the standing wave sensor having a constrained end and a free end;

FIG. 2 is a schematic diagram illustrating another exemplary embodiment of the standing wave sensor of the present invention, the standing wave sensor having two constrained ends;

FIG. 3 is a schematic diagram illustrating one exemplary embodiment of the standing wave sensors of the present invention used in a mixing application;

FIG. 4 is a schematic diagram illustrating one exemplary embodiment of the standing wave sensors of the present invention used in an attracting and shepherding application;

FIG. 5 is a schematic diagram illustrating one exemplary embodiment of the standing wave sensors of the present invention used in a uni or multi-directional fluid pumping and dispensing (i.e. flow directing) application;

FIG. 6 is a schematic diagram illustrating one exemplary embodiment of the standing wave sensors of the present invention used in a biosensing application;

FIG. 7 is a schematic diagram illustrating one exemplary embodiment of a sequenced method, using appropriate nanopositioners or the like, involving the insertion of the standing wave probes of the present invention into and removal of the standing wave probes of the present invention from a series of fluid filled wells or the like; and

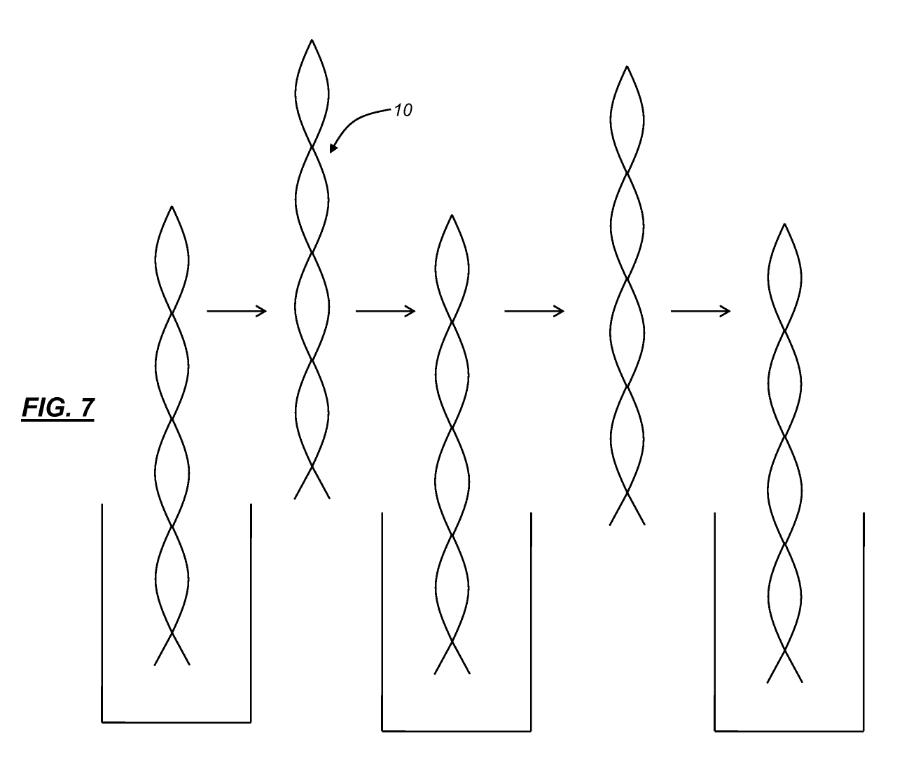

FIG. 8 is a schematic diagram illustrating one exemplary embodiment of a sequenced method, using appropriate nanopositioners or the like, involving the insertion of arrays of the standing wave probes of the present invention into and removal of arrays of the standing wave probes of the present invention from a series of arrays fluid filled wells or the like.

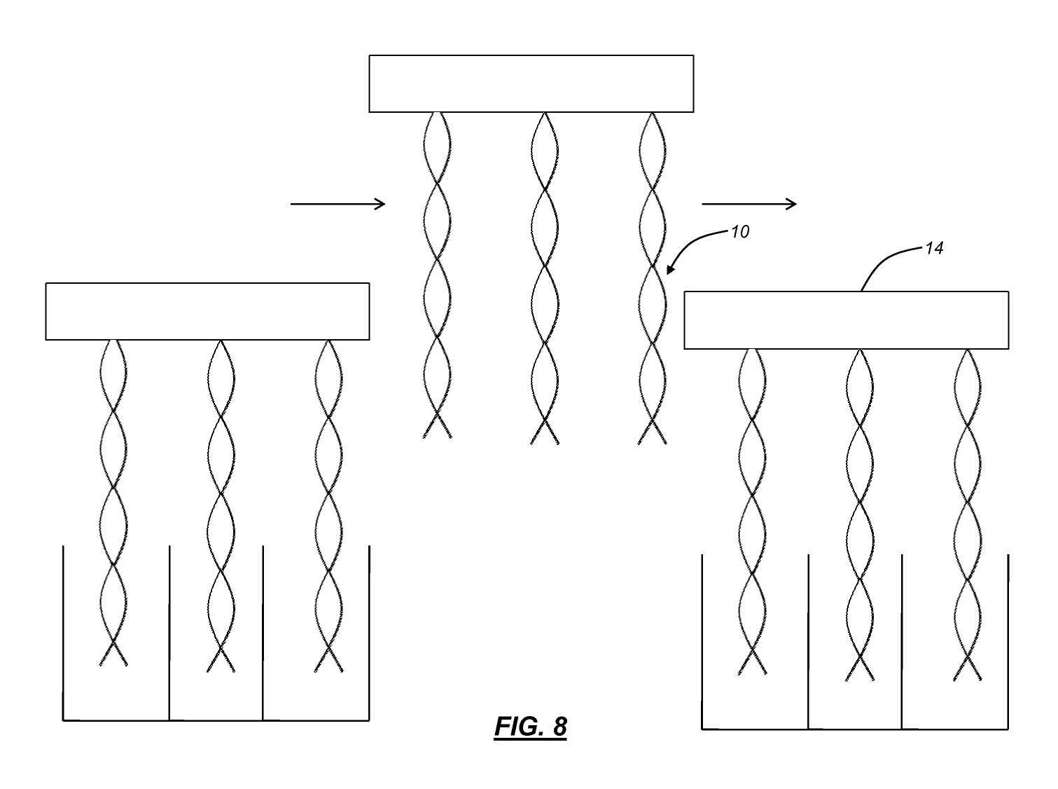

### DETAILED DESCRIPTION OF THE INVENTION

Again, in various exemplary embodiments, the present invention provides novel uses for the standing wave probes of U.S. Pat. No. 7,279,297 (Bauza et al.) and U.S. patent application Ser. No. 11/956,915 (Woody et al.), especially in fluidic and biological applications that involve liquid, gas, solid state, multi-phase, and viscoelastic environments and combinations thereof. As described in greater detail herein, these standing wave probes typically include a high-aspect ratio mesoscale (i.e. milliscale), microscale, nanoscale, or picoscale fiber that is directly or indirectly coupled to at least one actuator that applies oscillation cycles to the fiber, generating a standing wave in the fiber. The fiber may be constrained at one end, causing a virtual probe tip to be formed at the free end, or it may be constrained at both ends. In the later case, an actuator may be coupled to one or both ends of the fiber. Intervening constraints along the length of the fiber are also contemplated herein. In any case, the standing wave generated in the fiber is defined by both the characteristic shape of the oscillation cycles applied by the actuator(s) and the geometry of the fiber. The standing wave generated in the fiber may be along the longitudinal direction of the fiber, or may produce a semicircular motion around the axis of rotation of the fiber, for example, resulting in spiral like movements. Higher harmonic modes generated in the fiber produce higher potential and kinetic energy. Multiple standing wave probes may also be utilized in concert, as the configurations and methodologies of the present invention are very robust.

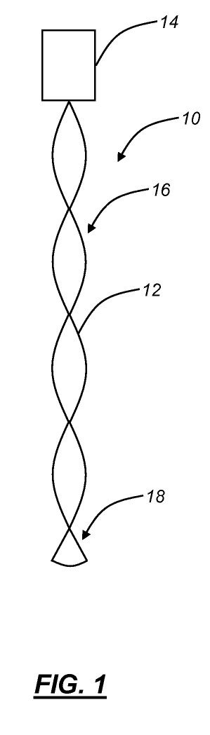

Referring to FIG. 1, in one exemplary embodiment, the standing wave sensor 10 of the present invention includes a high-aspect ratio mesoscale (i.e. milliscale), microscale, nanoscale, or picoscale fiber 12 that is coupled to at least one actuator 14 that applies oscillation cycles to the fiber 12, generating a standing wave 16 in the fiber 12. In this exemplary embodiment, the actuator 14 represents a constraint at one end, causing a virtual probe tip 18 to be formed at the free end. The actuator 14 may be, for example, a piezoelectric crystal actuator or the like including a plurality of thin flexure structures coupled to a plurality of electrodes. The actuator 14 may also be, for example, a non-mechanical actuator, such as pulsed light or other energetic waves used to actuate a carbon nanotube or the like. In such a case, the system for measuring the fiber response could be separate from the actuation system. All actuation methods that are capable of generating a standing wave in the fiber 12 are contemplated herein.

This technological platform is capable of operating as a combined sensor for detecting surface contact (physical or non-physical), self-sensing tweezers for grasping and releasing a component, an energy source for performing surface modification, and as described herein. Single and multi-dimensional standing waves are propagated at a rate on the order of kHz to MHz along the fiber 12. The magnitude of energy contained within the “wave packet” as compared to the flexibility/stiffness of the fiber 12 enables a pronounced single or multi-dimensional standing wave to be generated and sustained along the fiber 12. This “wave packet” is defined as an envelope containing an arbitrary number of waveforms that each have a specific position and momentum. As a result of the periodic energy transferred to the fiber 12, the combined energy arriving at and reflecting from the tip of the fiber 12 generates single or multi-dimensional geometrical patterns (such as hemispheres, ellipsoids, and other Lissajous-type shapes). The shape of the virtual probe tip 18 may be changed, where programmability is a function of the synchronization, magnitude, and modal shapes produced by the standing waves.

A time averaged picture of the oscillating fiber 12 produces an image of the oscillating standing wave sensor 10 as a solid volume traced out by the path of the outer surface of the fiber 12 that has a defined geometrical pattern. The standing wave probe 10 consists of the fiber 12; however, the virtual probe tip 18 consists of an integral of the path produced by the oscillating tip of the fiber 12. The outer locus of the virtual probe tip 18 consists of the total sum of motion produced by the very end of the fiber 12, thereby generating a pseudo field capable of interacting with other solids, surfaces, and fluids in near proximity. This programmable pseudo field (i.e. the virtual probe tip 18) may be employed across a wide variety of applications. It should be noted that the “virtual envelope” not including the virtual probe tip 18 behaves and may be used in the same manner. It should be noted that the advantage of the present technology is that the amplitude of the standing wave generated in the fiber is relatively great as compared to the dimensions of the fiber 12, which may have a given degree of rigidity such that it is described as “rigid,” “semi-rigid,” or “flexible.” This provides a great deal of potential and kinetic energy, such that the standing wave may be sustained relatively uninterrupted, even when disposed in a fluid.

As used herein, the terms “sensor,” “probe,” and the like are used interchangeably, and may imply devices that are actuated and may or may not provide sensing capability, depending upon the specific application involved. The present invention contemplates any and all arrayed uses of the “probes” described herein, in any and all orientation(s). Such arrayed uses are application specific. As used herein, the terms “elongated rod,” “filament,” “fiber,” and the like are also used interchangeably, and may be extended to include other thin films and high-aspect ratio mesoscale (i.e. milliscale), microscale, nanoscale, or picoscale structures. In fact, any mesoscale (i.e. milliscale), microscale, nanoscale, or picoscale structure—non-biological or biological—in which a standing wave may be generated is contemplated herein, regardless of its configuration. For example, the “fiber” may be a substantially rod-like structure, a substantially beam-like structure, a substantially tube-like structure, a substantially planar structure, or a structure of varying cross-section. It may be one of these structures with one or more other structures, such as one or more carbon nanotubes or the like, grown on it in order to increase its effective surface area. It may simply be a biological structure, such as a flagellum or the like, grown on an oscillator, or a mass of such biological structures. As used herein, the term “fluid” is used to refer to any liquid, gas, solid state, multi-phase, or viscoelastic environment or combination thereof, all of which are used interchangeably. The standing wave tools of the present invention may be used in any environment in which, in the most basic sense, interaction with one or more particles causes a change in the associated signal, allowing the tools to interact with the particle(s), whether or not signal feedback is utilized (i.e. the standing wave tools may be utilized for their physical functionality, and do not necessarily need to provide sensing signal, as the resulting particle interactions could be explored using optics, etc.).

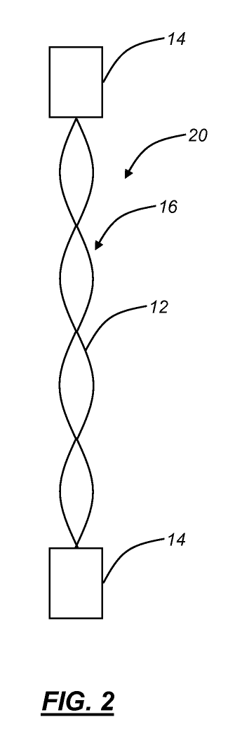

Referring to FIG. 2, in another exemplary embodiment, the standing wave sensor 20 of the present invention includes a high-aspect ratio mesoscale (i.e. milliscale), microscale, nanoscale, or picoscale fiber 12 that is coupled to at least one actuator 14 that applies oscillation cycles to the fiber 12, generating a standing wave 16 in the fiber 12. In this exemplary embodiment, the actuators 14 represent constraints at both ends. The actuators 14 may be, for example, piezoelectric crystal actuators or the like including a plurality of thin flexure structures coupled to a plurality of electrodes. The actuators 14 may also be, for example, non-mechanical actuators, such as pulsed light or other energetic waves used to actuate a carbon nanotube or the like. In such a case, the system for measuring the fiber response could be separate from the actuation system. All actuation methods that are capable of generating a standing wave in the fiber 12 are contemplated herein. In an alternative exemplary embodiment, an actuator 14 may be used at one end, while the other end is “fixed.” Intervening constraints along the length of the fiber are also contemplated herein. For example, a common actuation mechanism, disposed at a node of vibration, may be disposed between and/or used to actuate two fibers 12 (or two portions of a single fiber 12) in close proximity. Such a system may be constrained at each end, constrained at one end and have a virtual tip at the other end, or have a virtual tip at each end. All or a portion of this system may then be immersed in the fluid.

Again, single and multi-dimensional standing waves are propagated at a rate on the order of kHz to MHz along the fiber 12. The magnitude of energy contained within the “wave packet” as compared to the flexibility/stiffness of the fiber 12 enables a pronounced single or multi-dimensional standing wave to be generated and sustained along the fiber 12. This “wave packet” is defined as an envelope containing an arbitrary number of waveforms that each have a specific position and momentum.

Again, in various exemplary embodiments, the present invention provides novel uses for the standing wave probes 10, 20 of U.S. Pat. No. 7,279,297 (Bauza et al.) and U.S. patent application Ser. No. 11/956,915 (Woody et al.), especially in fluidic and biological applications that involve liquid, gas, solid state, multi-phase, and viscoelastic environments and combinations thereof.

### Micromixing Applications

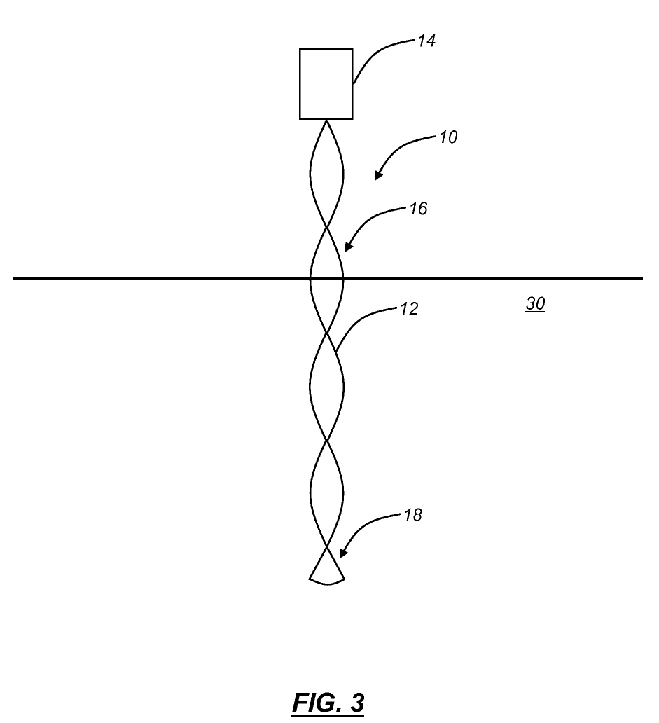

Referring to FIG. 3, in one exemplary embodiment, the standing wave probes 10, 20 of the present invention may be used in micromixing applications, with the oscillating fiber 12 of one or more of the standing wave probes 10, 20 at least partially disposed in a fluid 30, such as a liquid or a gas. In the exemplary embodiment illustrated, a single standing wave probe 10 having a virtual probe tip 18 is used. The fiber 12 is oscillated in one or more directions to provide different forms of mixing. The standing wave may be increased or decreased by increasing or decreasing the input drive voltage to the actuator 14. As the standing wave amplitude is varied, the rate of mixing varies. Therefore, the rate of mixing may be controlled by the electromechanical properties of the standing wave probe 10, or variations in the applied frequency. The use of multiple standing wave probes 10, or multiple fibers 12, in concert allows for more advanced mixing methodologies. The standing wave drive frequency utilized may also be varied in order to vary the rate or duration of the mixing. A faster standing wave enables faster mixing rates, for example. Optionally, the standing wave probes 10, 20 of the present invention may be embedded in microchannels or microwells and then used as micromixers. Similar to these micromixing applications, the standing wave probes 10, 20 could be used as microslicers.

### Attracting and Shepherding Applications

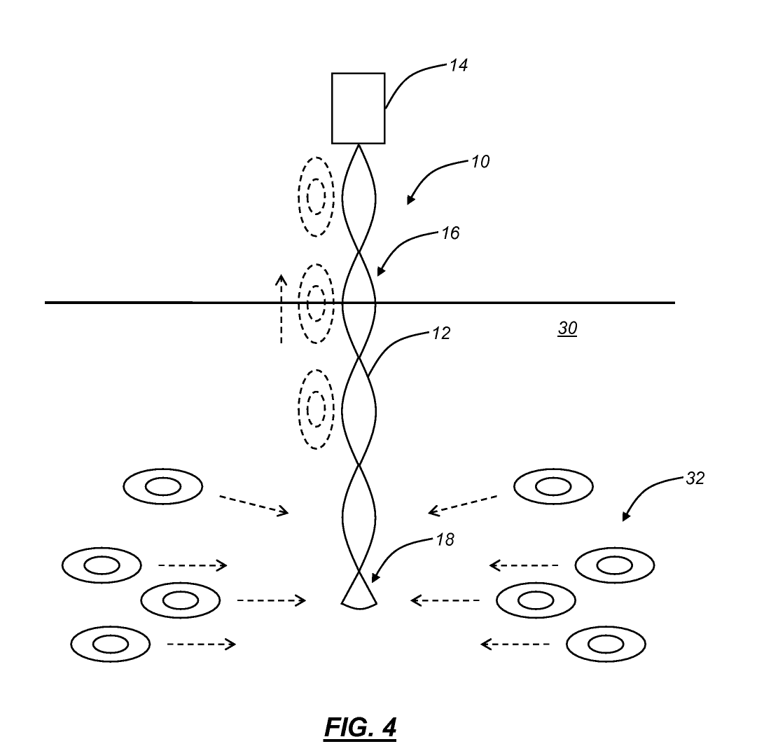

Referring to FIG. 4, in one exemplary embodiment, the standing wave probes 10, 20 of the present invention have, when actuated, been observed to attract microspheres, other particles, and even cells, individually 32, in a liquid or gas environment 30. For example, macrophage (i.e. mouse) cells 32 in a liquid environment 30 were observed to be attracted to the oscillating point source when actuated. The speed or rate of approach of these cells 32 was varied by varying the characteristics of the standing wave 16. The motion of the cells 32 was suddenly stopped by turning the standing wave 16 off. The cells 32 were observed to “group” around the oscillating point source and/or tip. Attracted particles have also been observed to be drawn to the “top” of the fiber via wicking or the like, even out of the fluid itself, and towards/to the tuning fork itself, allowing for much greater attraction to be achieved than that which would be expected by the fiber alone. This same wicking is observed with the fluid itself, various chemicals, etc. This is potentially a huge scientific advancement. Thus, the virtual probe tip 18 may be moved to lead cells 32 from location to location. This could have huge implications for microscopy, cell sorting, and diagnostic applications, among others. Other mesoscale (i.e. milliscale), microscale, nanoscale, or picoscale particles 32 are similarly attracted to the “vacuum” (i.e. vortex field or pressure differential) created by the standing wave probes 10, 20 of the present invention. The longer the standing wave 16 is active, the more material is attracted to it. This could have huge implications for a wide array of applications.

### Propulsion Applications

In nature, various organisms propel themselves via a spiral movement of a tail or the like. The energy of the potential semicircular motion around the axis of rotation of the fiber 12 associated with the standing wave 16, and resulting spiral like movements, may be used to propel the standing wave probe 10 relative to a liquid or gas environment 30. One or more fibers 12 may be excited in one or more directions to enable this propulsion. The unique energy generated in the mesoscale (i.e. milliscale), microscale, nanoscale, or picoscale fiber(s) 12 may be varied in one or more directions, oscillation frequencies may be varied, and oscillation amplitudes may be varied—all of which enable different forms of propulsion.

### Fluid Pumping and Dispensing Applications

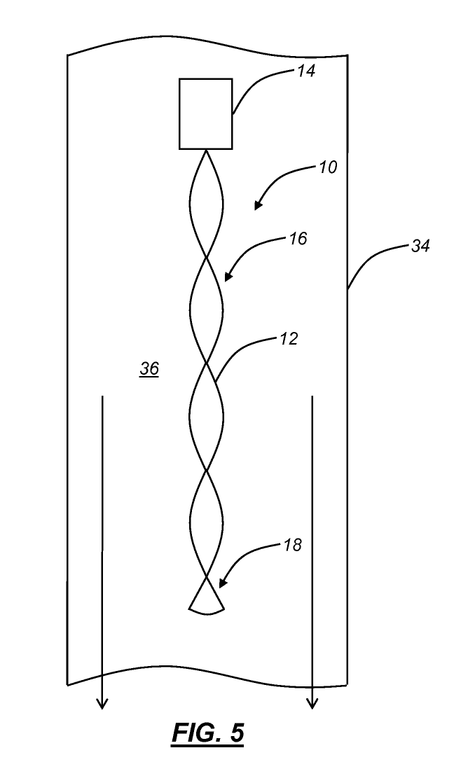

Referring to FIG. 5, in one exemplary embodiment, the standing wave probes 10, 20 of the present invention may be used in fluid pumping and dispensing (i.e. flow directing) applications. The standing wave probes 10, 20 may be disposed in a micropipette or nanopipette 34. A fluid 36 is then transferred along or across the standing wave(s) 16 and out of the pipette 34. Preferably, when the standing wave 16 is inactive, capillary forces prevent the fluid 36 from exiting the pipette 34. Once the standing wave 16 is activated, an amount of energy is used to direct the fluid 36 out of the pipette 34. Extending this further, the amount of energy may be adjusted by varying the oscillation frequency and amplitude of the standing wave 16. Thus, different rates of fluid expulsion may be generated.

### Cell Diagnostic Applications

The standing wave probes 10, 20 of the present invention may be used in self-sensing biological diagnostic applications. For example, a standing wave probe 10, 20 may be used to contact a cell and determine the cell wall stiffness and cell viscosity. Two or more standing wave probes 10, 20 may be used as miniature “tweezers” to squeeze a cell and measure its characteristics. Along these lines, two or more standing wave probes 10, 20 may be used to measure and evaluate an oocyte for invitro fertilization, determining whether or not it is healthy and increasing invitro fertilization yield. Standing wave probes may be used to probe tissue to determine localized mechanical stiffness, monitor physical changes in engineered gels, etc. For example, the standing wave probe of the present invention is essentially a force sensor and, as such, may be attached to a positioning device and used to track both force and position. It could be pressed against a cell and, utilizing this force and position information, used to characterize the localized mechanical stiffness of the cell, etc. Such uses are too numerous to provide an exhaustive list here.

### Biosensing Applications

The standing wave methodologies of the present invention have unique properties that enable biological sensing. More specifically, the standing wave methodologies of the present invention enable the diagnostic measurement of specific target biomolecules (i.e. antigens). These biosensors may sense typical antibody-antigen binding reactions occurring at the surface of the fiber 12. Under optimized conditions, a crystal oscillating tuning fork resonator or the like can increase the chances of antigen discovery if the probe is coated with an antibody because of the increased chances of “contact.”

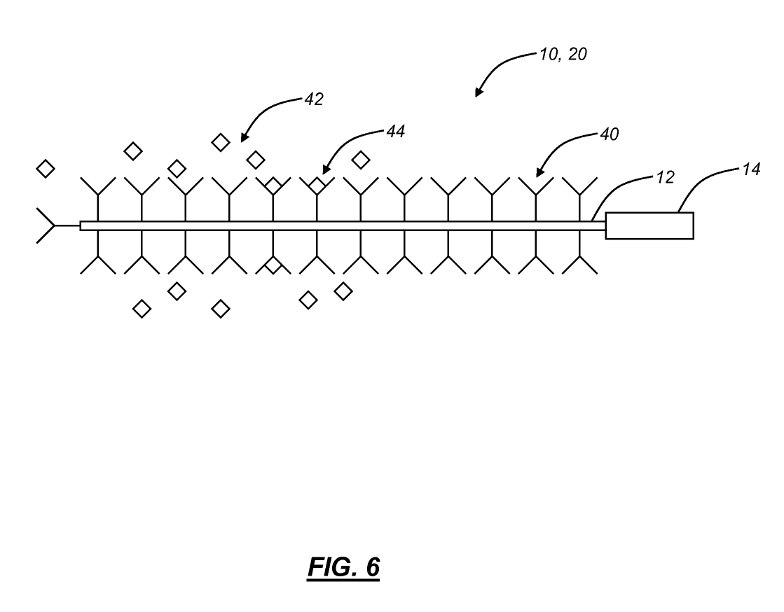

Referring to FIG. 6, in one exemplary embodiment, the fiber 12 is mechanically coupled to the actuator 14, such as a crystal oscillating tuning fork resonator or the like. The combined mechanical system is driven at the actuator's natural frequency. Depending upon the fiber's inherent characteristics, the fiber is excited at Mode 1 or higher modes, such as Mode 3. The actuator's oscillation amplitude creates the standing wave 16 (FIGS. 1-5) in the fiber 12. The actuator provides both an input signal, as well as a corresponding output signal that measures the electromechanical response. In a classical sense, the input and output signals may be monitored simultaneously for phase and magnitude in the frequency domain. Thus, state-of-the-art electronics, such as lock-in amplifiers and the like, may be used to track changes in the system's frequency response function. For example, if the sensor tip is brought into contact with soft tissue, the frequency response function provides different signal characteristics. Depending upon the sensitivity of the sensor, contacting or adding particles to the sensor changes the frequency response function reading of the sensor. Thus, the fiber 12 may be coated with specific receptor biomolecules 40 (i.e. antibodies) that selectively bind with specific target biomolecules 42 (i.e. antigens), thereby forming bound pairs 44 as the antigens 42 are attracted by the standing wave 16, as described above. These attracted antigens 42 change the frequency response function of the sensor as the “mass,” “stiffness,” or “energy dissipation” of the fiber 12 changes, allowing the antigens 42 to be detected and quantified.

The coating process described above (also known as functionalization) may be uniform, patterned, or nonuniform along the length of the fiber 12, depending upon the requirements of the biosensing application. There are several known techniques of functionalizing a cantilever-based biosensor. Similar approaches may be utilized to functionalize the fiber 12 here; however, it is not obvious to anyone of ordinary skill in the art to add functionalized receptor biomolecules 40 (i.e. antibodies) to standing wave or other novel or conventional resonating biosensors. One unique attribute of the fiber 12 is its high aspect ratio. This provides increased surface for the antibody-antigen binding reaction to take place. A second advantage of this system is the mixing effect of the standing wave biosensor 10, 20 when it is inserted into a liquid or gas, creating a greater probability that a target biomolecule 42 will come into contact with and therefore attach to a receptor biomolecule 40 on the surface of the fiber 12. As a result, antigens 42 that attach to the standing wave biosensor 10, 20 are more readily measured in a very small volume of liquid, for example.

Once the standing wave biosensor 10, 20 is functionalized with the receptor biomolecules 40 on its surface, the complete unit may be inserted into a liquid environment containing the target biomolecules 42 for detection. Once inserted into the liquid environment, the standing wave's energy generates vortices in the liquid environment, which allows the surface of the fiber 12 to come into close contact with the target biomolecules 42 and causes the target biomolecules 42 to be attracted and finally attached to the surface of the activated sensing element by antibody-antigen reaction. This form of activated attraction is referred to as bioshepherding.

Once the antigens 42 are attached, the standing wave biosensor's frequency response function changes as a result of the antigens 42 that are attached. This change may be measured in or out of the liquid environment. One possible method is to extract the standing wave biosensor 10, 20 out of the liquid environment with the antigens 42 attached to the antibodies 40. The antigens 42 may be dried and the sensor element activated to detect changes to the frequency response function.

Biosensing with a composite fiber 12 is also contemplated herein. If the fiber 12 is made of more than one material, the antibody-antigen reaction occurring at the surface of the fiber 12 will cause differential bending, which will change the frequency response function even more, aiding the detection process by amplifying the changes in the frequency response function. In a simpler version of this application, the standing wave sensor 10, 20 of the present invention may be used as a moisture sensor, indicating how much moisture is absorbed into and attached receptor material. In this exemplary application, it should be noted that the target material may be attracted to the receptor material via surface tension and then wicked along the elongated fiber(s) for collection, for example. As an alternative, the target material may simply be attracted to and held by the elongated fiber(s), and then be detected by another external methodology, such as fluorescing, etc. It should be noted that in this and other applications, the probe of the present invention may be inserted into a fluid for cleaning or surface preparation, for example, in the case of functionalization, and it may be removed from the fluid for shaking off attached fluid and particles, and accelerating drying, oxidation, and/or other reactions of the adhered particles or films.

The present invention provides a low frequency modulation device equipped with microscale fibers or the like. These fibers, when modulated, produce a pronounced mechanical wave that propagates back and forth in the ultrasonic frequency range. A change in modulation allows for the detection of attachment. Increasing specificity of the agent to bind is done by covalent attachment of a receptor, such as an antibody (as described above) or other protein, to the fiber. Thus, the present invention provides an analytic detection system that is capable of identifying and quantifying agents of interest, in general. The device consists of a specially coated fiber vibrating at low frequency that detects the binding of agents to the fiber by changes in the oscillation of the fiber.

Many proteins serve as natural receptors of specific ligands and have a degree of specificity and affinity to allow for development of a detection method for these ligands. For example, antibodies against microbes may be designed that recognize a specific organism and many membrane receptors may recognize a specific biological component. Oftentimes, these proteins may be used to generate a test that allows for detection of the species of interest. The present invention provides a device that is able to detect ligands binding to proteins, for example. The protein is covalently attached to a vibrating carbon fiber and the frequency and amplitude of the vibrations are monitored. The fiber changes its frequency and amplitude of vibration as the ligand binds, thus providing a detection system to monitor this effect. The detection of a biological contaminant, like a bacterium, is most useful if the presence of >100 CFU's of the bacteria may be detected within 15 minutes with the medium of the assay being still or flowing liquid or air. Such a system has far reaching potential uses. For example, attaching Bovine Serum Albumin (BSA) to a carbon fiber allows for several size agents to be monitored. Attachment of an antibody to the carbon allows for detection of a microbe. Appropriate experiments run with controls for viscosity and non-specific binding allow one to ascertain the range of agents and sensitivity of the test.

Thus, a particularly promising idea associated with the present invention is to attach protein A and G to the sensor (i.e. fiber). Protein A and G has many Fc receptor sites and most all antibodies have Fc receptors. Therefore, this makes it relatively easy to bind an antibody to protein A and G. Effort is spent modifying protein A and G to the fiber(s) and then anyone may attach their own antibody and make this specific for what they want to capture, collect, and/or detect. The standing wave probes of the present invention may then be used to rapidly collect, concentrate, and/or bind antigens to the fiber as long as the fiber is modified. The transducer on the back end (i.e. tuning fork) may be used to detect mass changes via resonance frequencies. Also, fluorescent techniques may be used as a form of detection (i.e. if the antibody fluoresces when present) when antigens bind to the fiber. A final method of sensing is to engineer the fiber to detect and sense mass changes itself. It should be noted that, in this exemplary application, the device may work where a ligand is on the probe or a receptor is on the probe. The detection is for what is not covalently attached and is in the surrounding media. The receptor may be a protein, an antibody, or any other recognition unit that will recognize a ligand. In this case, a ligand may be a small molecule, a protein or a organism like a bacteria or virus. The ability to detect may also allow for quantitation of the agent to be detected.

### Example—Liquid Handling and Micromixing for High Throughput Drug Discovery

As the population ages, there is a pressing need for new treatments, therefore the pharmaceutical industry is fervently increasing the number of new chemical entities that may potentially be turned into drugs. As the number of potential drug candidates (or leads) increases, the need for high throughput screening (HTS) will grow in parallel, making it necessary to have a highly automated HTS system. HTS enables researchers to rapidly conduct thousands of pharmacological, genetic, and biochemical tests to identity potential new drug candidates (or leads). The process provides the ability to identify parameters such as genes and active compounds, and thus enables faster insight to drug discovery and understanding the interactions of a biochemical process. Screening stations often comprise multiple instrumented platforms for robotic handling, dispensing, mixing, and detection. New instrumentation, including systems such as those for liquid and gas handling and detection, is one of the most crucial elements for the advance of automated HTS.

The HTS market represents a highly technological activity and pharma/biotech industries continue to face an increase in lead compounds. HTS and ultra-high throughput screening (UHTS) are emerging, requiring thousands if not millions of compounds to be tested each week. The pharmaceutical industry currently has a pressing need for improvement in HTS technology. Three key technological areas are critical to advancing the state of HTS. These include: 1) automation, 2) miniaturization, and 3) cost savings. Faster automation has a direct correlation to faster workflow for drug discovery and minimizing manual interventions is a key step. Miniaturization, the introduction of systems capable of handling nanoliter and picoliter sample quantities (i.e. microassay technology) is desired by companies, but is currently not commercially available. Such a capability will provide distinct advantages in reducing the cost per assay, increasing assay sensitivity, specificity, and speed. Finally, the number of chemical/biological assays continues to rise and the expenses in consumables and supplies continue to grow as well. Therefore, the industry continues to look for ways of significantly lowering the total cost of generating each HTS data point. As a result, the HTS industry continues to look for novel technologies that provide advanced automation, miniaturization, and that reduce the cost per data point.

A mesoscale (i.e. milliscale), microscale, nanoscale, or picoscale liquid or gas handling and micromixing probe is possible using the standing wave probe 10, 20 of the present invention, addressing miniaturization, cost savings, and faster automation in a single platform—additionally, it may be self-cleaning. For example, this technology utilizes a 7 μm microscale fiber 12 (with free lengths ranging from 1 to 5 mm) attached to a mechanical oscillator 14. Once the oscillator 14 is active, a pronounced mechanical wave operating at 32 kHz is induced in the fiber 12. The oscillator 14 also serves as a transducer with the capability to monitor precise mechanical changes in the standing wave 16. This technology has demonstrated nano-Newton force detection 1) when used as a tactile device for nanoscale dimensional measurements, 2) has been employed as a self sensing pick and place tool to pick up and weigh small mass samples such as picoliter droplets, 3) has been shown to concentrate particles and is currently being investigated for use in Raman spectroscopy, and 4) has demonstrated the capability to be used as a biosensor.

Using a modified standing wave probe 10, 20 consisting of a pair of microscale fibers 12 manufactured such that the gap between the fibers 12 (<100 microns) will cause fluid to wick between the rods 12, accurate measurement and dispensing capability is achieved. The pair of fibers 12 and a resonator 14 may be attached to a high speed nanopositioning device or the like. First, the oscillator 14 is activated, generating a standing wave 16 in the microscale fiber 12. Once the fiber 12 contacts the liquid or gas, the oscillator 14 immediately registers a response (i.e. in milliseconds) and a null position is set. Now the nanopositioner may controllably immerse the fibers 12 to a specified depth. Once the oscillator 14 is turned off, the probe is extracted from the fluid containing a small volume of fluid in the gap between the fibers 12. The amount of fluid wicked between the fibers 12 is highly deterministic for two reasons. First, the depth the fiber 12 is inserted into the fluid is always highly controlled. Second, once the probe 10, 20 is extracted from the fluid, the probe 10, 20 may operate with a low standing wave 16 (i.e. with a low enough energy to prevent fluid from releasing) and measure the mass of the liquid or gas, providing a fluid metering tool. The probe 10, 20 is then automatically translated to the next sequence and immersed into the target liquid or gas. Once immersed, a standing wave 16 is generated in the fibers 12, thus causing a mixing reaction to occur. Once a homogenous mixture occurs, the probe 10, 20 is removed and immersed into a cleaning fluid and activated again.

Within the HTS market, instruments used in drug discovery process are segmented into liquid handling robots, microplate readers, consumable supplies, imaging technology, microarray readers, microplate washers, and handling and software for data analysis. The technology of the present invention differentiates in two critical areas for liquid and gas handling and mixing. A lot of technologies traditionally dispense liquids through micropipettes into microplates, which are then placed on a shaker to mix. The drive towards miniaturization of assays for HTS requires precise, low-volume liquid-dispensing instrumentation. Over the last several years, automated instrumentation capable of handling low volume 384-well plates and well plates with 1,536 wells have entered labs. Liquid handling typically comprises a variety of tools such as pipettes, harvesters, plate and strip washers, and dispensing systems. Syringe technology is the most traditional source-to-destination fluid transfer methods and remains cost effective and versatile. Pipettors have been shown to be capable of accurately metering volumes as low as 100 nL, but they have difficulty of transferring smaller volumes to the destination without contact. Another more traditional liquid transfer technology is the “pin tool”, which allows fluid to wick onto the ends of metallic pins and then transfers the liquid to the targeted area. The size of the droplet is controlled by the cross sectional area of the pin with the smallest pin (with a diameter of 0.229 mm) providing a 7 nL dispensed droplet. The disadvantage with this method is that it cannot monitor the droplet size to ensure the exact amount of liquid transferred, it is not versatile in that it cannot change the size of the droplet, and there is no mixing capability.

More recently, liquid handling technology has trended toward piezoelectric, ink-jet, or solenoid actuation and away from traditional syringe technology. However, these dispensing technologies do not meter fluids. Additionally, these systems require substantial hardware and can therefore be very expensive if many channels are incorporated in the instrument. The systems function by using syringes that aspirate a certain amount of reagent and then dispense that amount. Some systems use a flow-through type dispenser, which does not require aspirating because it uses pressure to push the liquid through valves that open and shut to dispense the liquid. None of these dispensing tools have the ability to provide liquid transfer and liquid metering, nor do they provide active mixing capability for the samples. Finally, these technologies are challenging to miniaturize for microassays.

One distinct challenge in miniaturizing HTS systems is to be able to mix microfluids and solids, gasses, etc. Achieving the criteria of fast, efficient, and thorough (i.e. no concentration gradients) mixing has proven to be one of the main bottlenecks to achieving the potential benefits that microfluidics has to offer. Biological reactions which occur at the macroscale almost always involve the mixing of the biological specimen with reagents. In these systems, rapid homogeneous mixing of liquid solutions is considered one of the most challenging issues. This is particularly true for solution streams containing micromolecules (i.e. DNA, cells, proteins, etc.) or large particles (i.e. bacteria) which have diffusion coefficients orders of magnitude lower than most fluids. Concentration gradients between two fluids being mixed can affect the outcome of the process. Mixing (whether in the lab-on-a-chip (LOC) system or applied to conventional processes) can accelerate hybridization kinetics and improve uniformity of the hybridization in a shallow chamber (i.e. a PCR tube, well plate, or microfluidic chamber). Particular difficulties arise where small, finite volumes of liquids must be mixed, such as in the case of microassays. The crux of the problem lies in the fact that the typical Reynolds number for micron-scale fluidic systems is small, usually considerably less than 1000, and this means that the traditional phenomena available for mixing (that of turbulent velocity motion) is not available since the fluid flow is laminar. Thus, only molecular diffusion is available for mixing. From dimensional analysis, typical timescales for laminar diffusion are given by Tlam=D/L2 where D is the diffusion coefficient and L is the characteristic length scale of the system. For a typical biological system (e.g. mixing a moderately-sized protein in a 100 micron channel), Tlam is ˜500 sec, far too long for any practical application. Proposed solutions to micromixing are divided into passive and active methods. Passive methods require no input energy and achieve enhanced mixing either by elongation of laminar interfaces such as serpentine channels or by a “divide-and-conquer” scheme in which the two streams are divided into multiple parallel paths and mixed in sub-streams. A second approach is to induce chaotic mixing through geometric complexity, such as a 3D channel geometry, or by textured surfaces. These techniques improve the mixing efficiency and speed when compared with plane channel geometries, but still require relatively large Reynolds numbers (to induce the necessary secondary flows required for chaotic motion) and still require flow-through systems rather than residential microreactors. Batch micromixing cases tend to be more applicable where, for example, in pathological screening tests a drop of patients blood is mixed with a reagent for screening type pathology tests or for biochips requiring DNA hybridization. The mixing should occur using a simple, economical device enabling cost effective HTS processes feasible, point-of-care immunoassays, and such applications typically favor active mixing approaches.

Active mixers use some form of energy input to induce fluid motion which enhances mixing, a manifold of approaches have been proposed including electrokinetic, magnetic beads, external pumping motion, and even live bacteria. A complication to active mixing is that at low Reynolds numbers, any unsteady motion introduced into the microsystem is often reversible, and thus any mechanisms that might otherwise stir the fluid in a macroscopic configuration often has little added benefit at small scale. To address this, chaotic mixing strategies or the use of inherent instabilities are often adopted. Nevertheless, a significant drawback of many previously-demonstrated systems is that many of these active systems require that either a foreign substance be present in the fluid (e.g. magnetic beads, dielectric particles, etc.) or that the fluid have some rather specific properties (pH, conductivity, thermal coefficient of density, etc.).

The challenge, thus, is to design a system that is capable of receiving a single drop, without a complex liquid feeding system, and to mix the drop efficiently enough with the reagent for any binding reactions to occur over a timescale of tens of seconds rather than hours. This requires implementing a simple cost effective active mixing mechanism that does not cause damage to the biological samples or require the introduction of foreign agents into the fluid stream. This is the technology offered by the present invention.

By coupling the fiber 12 to a mechanical resonator 14 having a high mechanical Q, an unprecedented type of energy in the form of a standing wave 16 is propagated along the fiber 12, sustained, and finally used for environmental sensing. The geometric volume of the fiber 12 compared to the elastic deformation propagated in the fiber 12 exhibits an unprecedented amount of potential and kinematic energy occurring in a small form factor. The standing wave's amplitude and mode shape are dependent upon many factors including: 1) the fiber's material properties and geometric scaling, 2) the input drive frequency and oscillation amplitude, and, finally, 3) the damping properties due to the bonding agent between the fiber and oscillator. The pronounced wave pattern is exhibited in a one dimensional fashion and the amplitude may vary depending upon the input drive frequency or peak-peak drive voltage transferred to the tuning fork 14.

As described above, the standing wave technology may be implemented to sense environmental interactions. The tuning fork resonators 14 provide electrodes for actuation as well as sensing the mechanical response from the resonator 14. By sweeping through drive frequencies, the output sensor signal compared to the drive voltage will shift by 180 degrees when passing through the natural frequency. This shift in phase and magnitude response may then be used as a form of measurement for a variety of parameters including dimensional measurements and force. A variety of signal conditioning electronics have been developed and used to extract precision signals.

### Example—Viscometry and Rheology of Microsamples

The measurement of the physical properties of liquids and gasses, specifically the viscosity and rheological behavior of materials, is very important for process engineering and analytical research. Measurements of viscosity during processing, manufacturing, and production is necessary across a wide range of industries such as biochemistry, fuel oil production, and research including biofuels, bodily fluid/blood analysis, polymer processing, food production and research, biomedical applications, such as blood analysis, and in metals processing. Additionally, in situations, specifically in the fields of biology and medicine (e.g. clinical laboratory testing) the amount of liquid available for measurement is quite small or the cost of the liquids is high resulting in a desire to use small quantities whenever possible.

In the viscometry and rheology equipment markets the demand for viscometers and rheometers is driven by the need to determine flow behavior of fluids. Viscometers enable the ability to measure viscous properties of fluids such as liquids, semi-solids, and gasses either in an industrial setting or in a laboratory environment. This is a necessary quality control step in the production of most fluids, creams, and gels in order to ensure product consistency and quality to fulfill customer demands, and therefore these measurements influence cost efficiency to a great extent. There are so many varied techniques to make viscosity and rheology measurements that it becomes imperative to choose the most suitable instrument for use in specific applications. However, there is a lack of technological innovation in this area which restrains growth of the market because there has been little or no innovation for nearly half a century. Nonetheless, manufacturers have been striving to improve product performance by focusing on automation, user-friendly instruments, and reliability and accuracy. There is a growing need for a device designed to measure microsamples (on the order of microliters) to address drug discovery, biotech, and medical application markets. A viscosity measurement technology that could use less than 20 μL sample size and be configured as a laboratory instrument or a flow through measurement device is unique.

The standing wave probes 10, 20 of the present invention may be used as a mesoscale (i.e. milliscale), microscale, nanoscale, or picoscale viscometry sensor, with the potential to quantify both bulk fluids and microfluids in a production or laboratory environment. For example, the concept again uses a 7 μm microscale fiber 12 (with free lengths ranging from 1 to 5 mm) attached to a mechanical oscillator 14. Once the oscillator 14 is active, a pronounced mechanical wave operating at 32 KHz is induced in the fiber 12. The oscillator 14 also serves as a transducer with the capability to monitor small mechanical changes in the standing wave 16. This technique has the benefit that it is simple, inexpensive, quick, and can work on small sample volumes (microliters) as well as bulk samples.

Viscosity is a property of a fluid that offers resistance to flow. Therefore, it is the ratio of the shearing stress to the velocity gradient in a fluid. Most fluids, such as air and water, exhibit a linear relationship between shear stress versus shear rate. When plotting this relationship, the slope is the viscosity of the fluid. Additionally, the viscosity is a function of the temperature. One common example is lubricants, whose viscosity can double with a change of only 5° C. For some fluids, it is a constant over a wide range of shear rates. Fluids with a constant viscosity (i.e. a linear relationship) are called Newtonian. Any fluid that does not have this linear relationship is called non-Newtonian, that is the viscosity of the fluid is dependent on shear rate. Their viscosity cannot be described by a single number. Rheology is the study of the behavior of these types of fluids and their dependence on shear. There is actually more than one quantity that is called viscosity. The most common and the one described above is often referred to as dynamic viscosity, absolute viscosity, or simply viscosity. The other quantity, called kinematic viscosity, is the ratio of the viscosity of a fluid to its density. It is frequently measured using a device called a capillary viscometer and measured in units called centiPoise (cP).

For the past 50 years, viscometry instrumentation and methodologies have remained predominantly unchanged. Technologies include cup and drop, capillary and rotating element viscometers. The rotating element viscometer gives quantitative results for a limited measurement range and accuracy. Viscosity measurements on the these traditional technologies are tedious, and in many instances the flow time is lengthy. More recently a number of resonance based viscosity sensing devices have been introduced in the literature, several of which have become commercial products in various forms and sizes and targeting different application areas. These methods operate by measuring the damping of an electromechanical resonator immersed in a fluid sample. For example, larger damping on the resonator indicates higher viscosity.

However, there are several downfalls to directly inserting the tuning fork into the liquid. One disadvantage of this technique is the lack of a defined shear field which makes it unsuitable for measuring viscosity of fluids due to unknown flow behavior. Additionally, tuning fork resonators fall short when measuring viscosity and density of electrolytes (tap water and low purity grade alcohols for example) because of the electric field generated in the liquid and coating the tuning fork does not solve the problem. Another complication is that the quality factor (Q) which directly affects sensitivity, decreased from ˜7000 in air to as low as 10 in liquid. One proposed solution is to increase the drive voltage to as much as 1500 V, but this is undesirable. The approach of the present invention also uses high frequency vibrations created by a tuning fork resonator, but the boundary conditions, measurement techniques, and mechanical waves are distinctly different. However, the success of using tuning fork resonators substantiates the validity of this methodology. Because in the methodology the resonator does not make direct contact with the fluid, it does not experience the reduced Q and therefore the method provides better sensitivity compared with the methods described above.

Again, by coupling the fiber 12 to a mechanical resonator 14 having a high mechanical Q, an unprecedented type of energy in the form of a standing wave 16 is propagated along the fiber 12, sustained, and finally used for environmental sensing. The geometric volume of the fiber 12 compared to the elastic deformation propagated in the fiber 12 exhibits an unprecedented amount of potential and kinematic energy occurring in a small form factor. The standing wave's amplitude and mode shape are dependent upon many factors including: 1) the fiber's material properties and geometric scaling, 2) the input drive frequency and oscillation amplitude, and, finally, 3) the damping properties due to the bonding agent between the fiber and oscillator. The pronounced wave pattern is exhibited in a one dimensional fashion and the amplitude may vary depending upon the input drive frequency or peak-peak drive voltage transferred to the tuning fork 14.

As described above, the standing wave technology may be implemented to sense environmental interactions. The tuning fork resonators 14 provide electrodes for actuation as well as sensing the mechanical response from the resonator 14. By sweeping through drive frequencies, the output sensor signal compared to the drive voltage will shift by 180 degrees when passing through the natural frequency. This shift in phase and magnitude response may then be used as a form of measurement for a variety of parameters including dimensional measurements and force. A variety of signal conditioning electronics including lock-in amplifiers and phase lock loop electronics have been developed and used to extract precision signals.

The equivalent circuit for a tuning fork includes two parallel impedances. The first is the static capacitance, C0, of the tuning fork, and the second is the tuning fork dynamics, represented by the three elements C1, the compliance, L1, the mass, and R1, the dissipation of the fork. A high aspect ratio microscale fiber coupled to a mechanical resonator would have the same basic model with different values for the circuit elements. The effective result is a more sensitive system based on the fact that the fiber will absorb more energy because it vibrates at a much higher amplitude than the motion of the tuning fork tines. This exemplary model can be extended to include an additional impedance ZL produced by the surrounding liquid. This impedance is related to the operational frequency, liquid density, and liquid viscosity.

In other methodologies, when the tuning fork makes contact with the liquid, the static capacitance, C0, will also be affected by the electrical properties of the surrounding liquid. This complication by the methodology of the present invention. If the tuning fork is submerged in the liquid, the signal is significantly damped and the signal to noise will decrease significantly making any noise in the system a significant contribution in the measurement, decreasing the accuracy of the methodology.

It is well established that a higher mechanical ‘Q’ oscillator relates to higher sensitivity and even feasibility for advanced applications. The ‘Q’ is a dimensionless value that compares the oscillator's amplitude to the resonance frequency. The oscillator's input and output signals are compared for shifts in resonant frequency, magnitude, and phase. If the oscillator has a high Q, a small shift in frequency away from resonance will result in a rapid decay of the output signal. Conversely, a low Q will result in a small rate of decay in electrical signal. If the sensor's signal change decreases below the RMS noise then the sensor is simply unable to detect. Therefore, the general rule is to design resonators with higher mechanical Q's for realizing highly precise sensing. The oscillators typically reported have significantly low mechanical Q where the best values do not exceed 100. However, the Q value for the standing wave sensor while measuring in liquid is a factor of 20-30 times higher. The fundamental difference is the conventional oscillators are partially or fully immersed in the liquid and are therefore highly damped which directly affects the sensitivity. The present invention, on the other hand, immerses the mesoscale (i.e. milliscale), microscale, nanoscale, or picoscale fiber in the fluid. Although the fiber is small in comparison to the tuning fork, very small changes in frequency and magnitude may be resolved, thereby leading to precise mesoscale (i.e. milliscale), microscale, nanoscale, or picoscale sensor for fluid property measurements.

Although the present invention is illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A standing wave tool, comprising:
at least one elongated fiber that has small scale dimensions, the at least one elongated fiber comprising at least a first end and a second end; and
an actuator directly or indirectly coupled to the first end of the at least one elongated fiber,
wherein the actuator is operable for applying oscillation cycles to the at least one elongated fiber in one or more directions, and
wherein the actuator is operable for generating a standing wave in the at least one elongated fiber.

2. The standing wave tool of claim 1, wherein the second end of the at least one elongated fiber is unconstrained.

3. The standing wave tool of claim 1, wherein the second end of the at least one elongated fiber is constrained.

4. The standing wave tool of claim 1, wherein the at least one elongated fiber is constrained between the first end and the second end.

5. The standing wave tool of claim 1, further comprising:
an actuator directly or indirectly coupled to the second end of the at least one elongated fiber,
wherein the actuator is operable for applying oscillation cycles to the at least one elongated fiber in one or more directions, and
wherein the actuator is operable for generating a standing wave in the at least one elongated fiber.

6. The standing wave tool of claim 1, wherein the at least one elongated fiber comprises one of a substantially rod-like structure, a substantially beam-like structure, a substantially tube-like structure, a substantially planar structure, a structure of varying cross-section, a biological structure, and a combination thereof.

7. The standing wave tool of claim 1, wherein the at least one elongated fiber comprises a composite structure comprising a plurality of materials or one material comprising a plurality of properties.

8. A method for utilizing a standing wave tool in a fluidic and/or biological environment, comprising:
providing at least one elongated fiber that has small scale dimensions, the at least one elongated fiber comprising at least a first end and a second end;
providing an actuator directly or indirectly coupled to the first end of the at least one elongated fiber,
wherein the actuator is operable for applying oscillation cycles to the at least one elongated fiber in one or more directions, and
wherein the actuator is operable for generating a standing wave in the at least one elongated fiber; and
disposing at least a portion of the at least one elongated fiber in a fluid.

9. The method for utilizing a standing wave tool of claim 8, wherein the second end of the at least one elongated fiber is unconstrained.

10. The method for utilizing a standing wave tool of claim 8, wherein the second end of the at least one elongated fiber is constrained.

11. The method for utilizing a standing wave tool of claim 8, wherein the at least one elongated fiber is constrained between the first end and the second end.

12. The method for utilizing a standing wave tool of claim 8, further comprising:
providing an actuator directly or indirectly coupled to the second end of the at least one elongated fiber,
wherein the actuator is operable for applying oscillation cycles to the at least one elongated fiber in one or more directions, and
wherein the actuator is operable for generating a standing wave in the at least one elongated fiber.

13. The method for utilizing a standing wave tool of claim 8, wherein the at least one elongated fiber comprises one of a substantially rod-like structure, a substantially beam-like structure, a substantially tube-like structure, a substantially planar structure, a structure of varying cross-section, a biological structure, and a combination thereof.

14. The method for utilizing a standing wave tool of claim 8, wherein the at least one elongated fiber comprises a composite structure comprising a plurality of materials or one material comprising a plurality of properties.

15. The method for utilizing a standing wave tool of claim 8, further comprising quantifying a change in a frequency response function of the at least one elongated fiber.

16. The method for utilizing a standing wave tool of claim 8, wherein the at least one elongated fiber provides a function selected from the group consisting of mixing the fluid, measuring the viscosity of the fluid, attracting particles in the fluid, shepherding particles in the fluid, providing propulsive force in the fluid, pumping the fluid, dispensing the fluid, sensing particles in the fluid, detecting particles in the fluid, measuring a mechanical stiffness of particles in the fluid, wicking the fluid, and wicking particles in the fluid.

17. The method for utilizing a standing wave tool of claim 8, further comprising disposing at least a portion of the at least one elongated fiber concentrically within a channel structure.

18. The method for utilizing a standing wave tool of claim 8, further comprising removing at least a portion of the at least one elongated fiber from the fluid.

19. A standing wave tool, comprising:
at least one elongated fiber that has small scale dimensions, the at least one elongated fiber comprising at least a first end and a second end;
an actuator directly or indirectly coupled to the first end of the at least one elongated fiber,
wherein the actuator is operable for applying oscillation cycles to the at least one elongated fiber in one or more directions, and
wherein the actuator is operable for generating a standing wave in the at least one elongated fiber; and
a receptor material disposed on a surface of the at least one elongated fiber,
wherein the receptor material is operable for interacting with a target material disposed in a fluid.

20. The standing wave tool of claim 19, wherein a frequency response function of the at least one elongated fiber changes when the receptor material interacts with the target material.

21. The standing wave tool of claim 19, wherein the receptor material comprises a first biomolecule and the target material comprises a second biomolecule.

22. A method for utilizing a standing wave tool in a fluidic and/or biological environment, comprising:
providing at least one elongated fiber that has small scale dimensions, the at least one elongated fiber comprising a first end and a second end;
providing an actuator directly or indirectly coupled to the first end of the at least one elongated fiber,
wherein the actuator is operable for applying oscillation cycles to the at least one elongated fiber in one or more directions, and
wherein the actuator is operable for generating a standing wave in the at least one elongated fiber; and
providing a receptor material disposed on a surface of the at least one elongated fiber,
wherein the receptor material is operable for interacting with a target material disposed in a fluid.

23. The method for utilizing a standing wave tool of claim 22, further comprising obtaining a frequency response function of the at least one elongated fiber before and after the receptor material interacts with the target material.

24. The method for utilizing a standing wave tool of claim 22, wherein the receptor material comprises a first biomolecule and the target material comprises a second biomolecule.

25. The method for utilizing a standing wave tool of claim 22, further comprising capturing the target material with the at least one elongated fiber.

26. The method for utilizing a standing wave tool of claim 25, further comprising wicking the target material along the at least one elongated fiber.

27. The method for utilizing a standing wave tool of claim 22, further comprising using an external method for detecting the presence of the target material on the at least one elongated fiber.
